(19) United States
(12) Patent Application Publication
(10) Pub. No.: US 2012/0097804 A1
(43) Pub. Date: Apr. 26, 2012

(54) CABLE MANAGEMENT APPARATUS

(75) Inventor: LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/945,895

(22) Filed: Nov. 15, 2010

(30) Foreign Application Priority Data
Oct. 21, 2010 (CN) 201010514524.4

(51) Int. Cl. F16L 3/12; F16L 3/00

(52) U.S. Cl. 248/68.1

(57) ABSTRACT

A cable management apparatus includes a bracket having a post, and a clamp mounted to the bracket. The clamp includes a support plate, a binding member to accommodate cables, and a latch member. The binding member and the latch member are positioned on opposite sides of the support plate, respectively. A through hole is bounded by the support plate and the latch member. The post of the bracket extends through the through hole of the clamp and adjustably engages with the latch member to adjustably fasten the clamp to the bracket.

### CROSS-REFERENCE OF RELATED APPLICATION

A relevant subject matter is disclosed in a co-pending U.S. patent application, entitled “CABLE MANAGEMENT APPARATUS”, with application Ser. No. 12/898,650, filed on Oct. 5, 2010, which is assigned to the same assignee as this present application.

### BACKGROUND

1. Technical Field

The present disclosure relates to management apparatuses, and more particularly to a cable management apparatus.

2. Description of Related Art

Generally, in computers or servers, cable management apparatuses are used to bind cables used in the computers or servers. However, ordinarily, the cable management apparatus is hard to adjust, so the cable management apparatus generally needs to be replaced when the position of the cables needs to be adjusted, which is inconvenient and costly.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a management apparatus for cables; the management apparatus includes a clamp.

FIG. 2 is an enlarged view of the clamp of FIG. 1, but viewed from another perspective.

FIG. 3 is an assembled, isometric view of the management apparatus of FIG. 1.

FIG. 4 is an exploded, isometric view of another exemplary embodiment of a management apparatus for cables; the management apparatus includes a clamp.

FIG. 5 is an enlarged view of the clamp of FIG. 4, but viewed from another perspective.

FIG. 6 is an assembled, isometric view of the management apparatus of FIG. 4.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

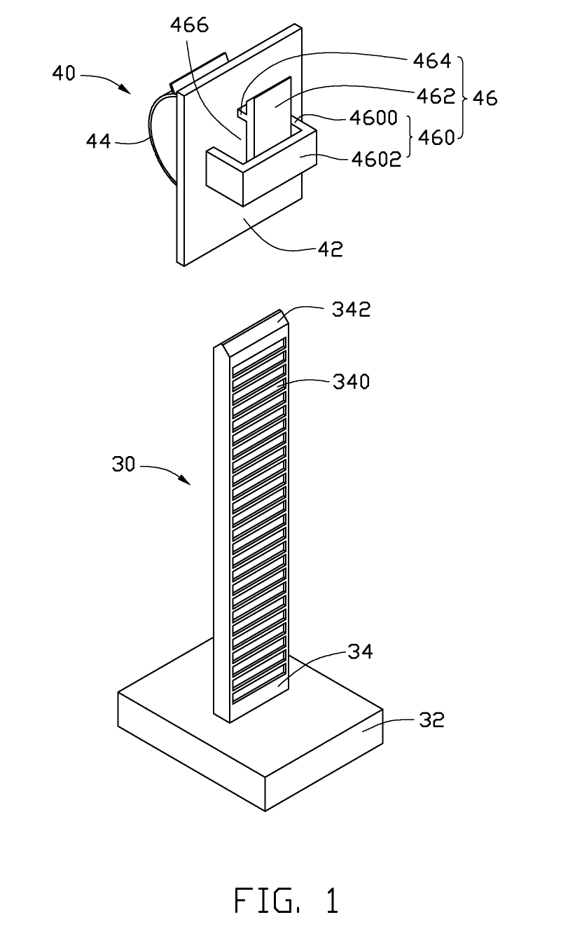

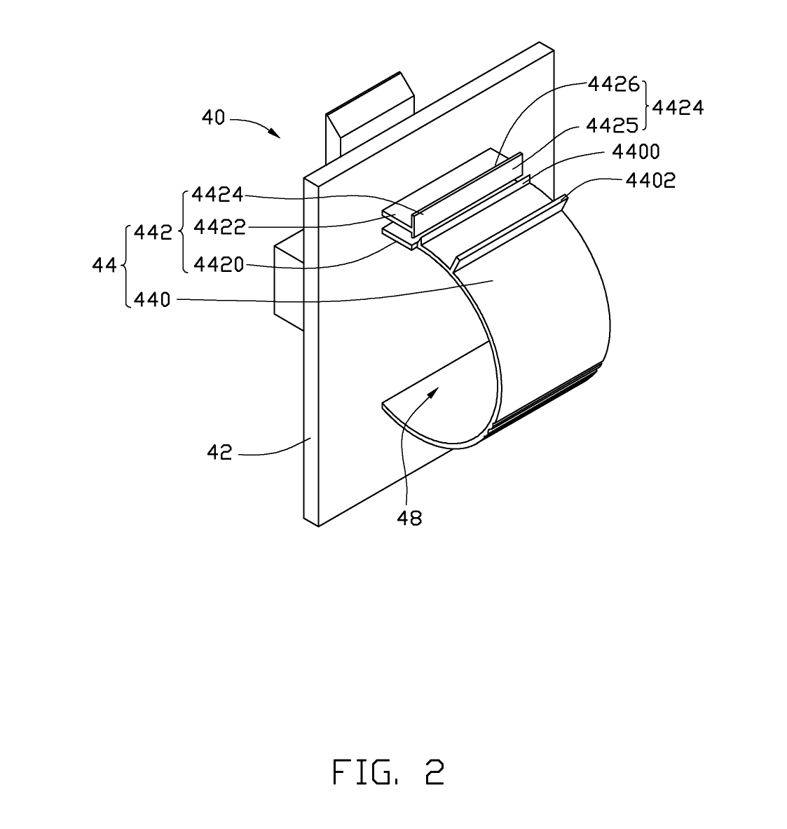

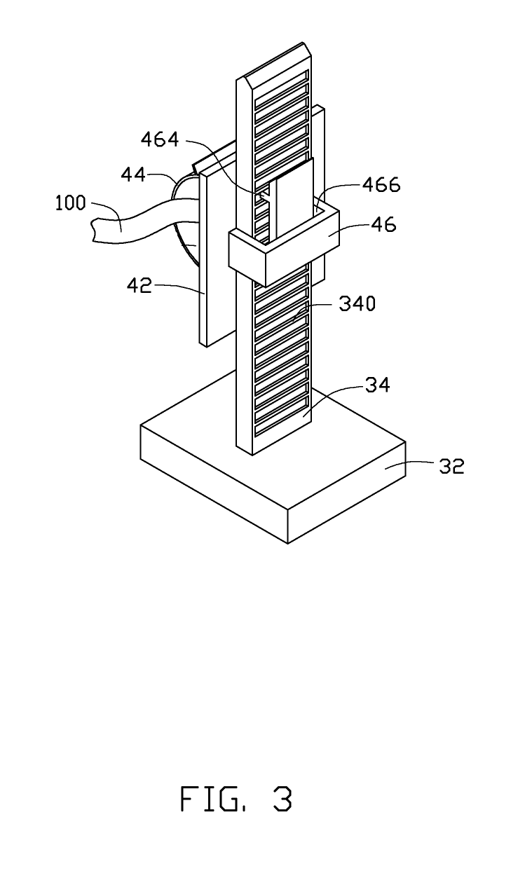

Referring to FIGS. 1 to 3, a first exemplary embodiment of a cable management apparatus used to bind cables 100 includes a bracket 30, and a clamp 40 mounted to the bracket 30.

The bracket 30 includes a base plate 32, and a post 34 perpendicularly extending up from a center of the base plate 32. The post 34 is substantially plate-shaped. A lateral surface facing outside of the post 34 defines a plurality of latching slots 340. A top end of the post 34 forms a tapered guide portion 342.

The clamp 40 includes a substantially rectangular support plate 42, a binding member 44, and a latch member 46. The binding member 44 and the latch member 46 are positioned on opposite first and second sides of the support plate 42, respectively. The binding member 44 includes a flexible binding strip 440 and a clamp portion 442. The binding strip 440 includes a first end fixed to a lower portion of the first side of the support plate 42 and a second end opposite to the first end. A bar-shaped protrusion 4400 protrudes from the second end of the binding strip 440. The cross section of the protrusion 4400 is wedge-shaped. An operation portion 4402 protrudes from the binding strip 440, adjacent and parallel to the protrusion 4400.

The clamp portion 442 includes a first clamp sheet 4420 perpendicularly extending from an upper portion of the first side of the support plate 42, and a second clamp sheet 4422 perpendicularly extending from the upper portion of the first side of the support plate 42 and parallel to the first clamp sheet 4420. A third clamp sheet 4424 perpendicularly extends from a distant end of the second clamp sheet 4422, opposite to the support plate 42. The third clamp sheet 4424 includes a first portion 4425 extending toward the first clamp sheet 4420, and a second portion 4426 extending away from the first clamp sheet 4420.

The latch member 46 includes a substantially U-shaped limiting portion 460, a latch plate 462, and a latch 464. The limiting portion 460 includes two parallel first limiting plates 4600 perpendicularly extending from the second side of the support plate 42, and a second limiting plate 4602 connected between distal ends of the first limiting plates 4600, parallel and opposite to the support plate 42. The latch plate 462 extends up from an inner side of the second limiting plate 4602, parallel to and facing the support plate 42. A through hole 466 is bounded by the support plate 42 and the latch plate 462. The latch 464 perpendicularly protrudes from the latch plate 462, facing the support plate 42.

In assembly, the latch plate 462 is deformed away from the support plate 42, and the post 34 of the bracket 30 extends through the through hole 466 of the clamp 40. After the clamp 40 is moved to a predetermined height of the post 34 of the bracket 30, the latch plate 462 is released to be restored. The latch 464 of the latch member 46 engages in a corresponding latching slot 340 of the post 34 to fasten the clamp 40 to the bracket 30. The tapered guide portion 342 can guide the post 34 to conveniently extend through the through hole 466.

In use, the cables 100 are accommodated between the support plate 42 and the binding member 44. The second portion 4426 of the third clamp sheet 4424 of the clamp portion 442 is operated to deform the second clamp sheet 4422 away from the first clamp sheet 4420. The binding member 44 is bent to be C-shaped; with the second end of the binding strip 440 and the protrusion 4400 accommodated between the first and second clamp sheets 4420 and 4422. The second portion 4426 of the third clamp sheet 4424 is released, and thus the second clamp sheet 4422 is restored. The protrusion 4400 is then blocked by the first portion 4425 of the third clamp sheet 4424. Therefore, the cables 100 are restricted in a receiving space 48 bounded by the binding strip 440 and the support plate 42. In disassembling the cables 100 from the clamp 40, the second portion 4426 of the third clamp sheet 4424 of the clamp portion 442 is operated to move away from the first clamp sheet 4420, therefore, the second portion 4425 of the third clamp sheet 4424 disengages from the protrusion 4400 of the binding strip 440. The operation portion 4402 of the binding strip 440 is operated to expand the binding strip 440, thereby, the cables 100 are readily removed from the support plate 42. To reposition the cables 100, the latch plate 462 is deformed away from the support plate 42, and the clamp 40 is slid along the post 34, then the latch plate 462 is released, with the latch 464 engaging in another latching slot 340 of the post 34. Thereby, the position of the cables 100 is conveniently changed.

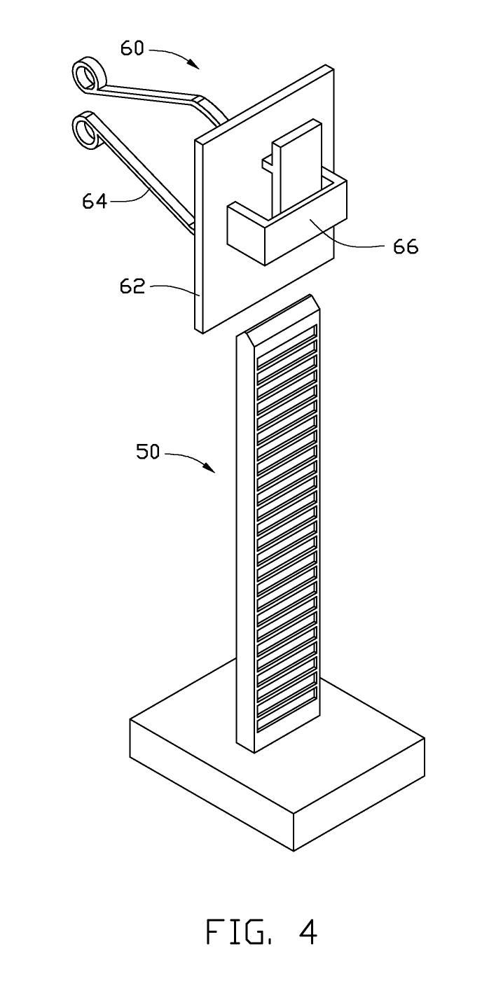

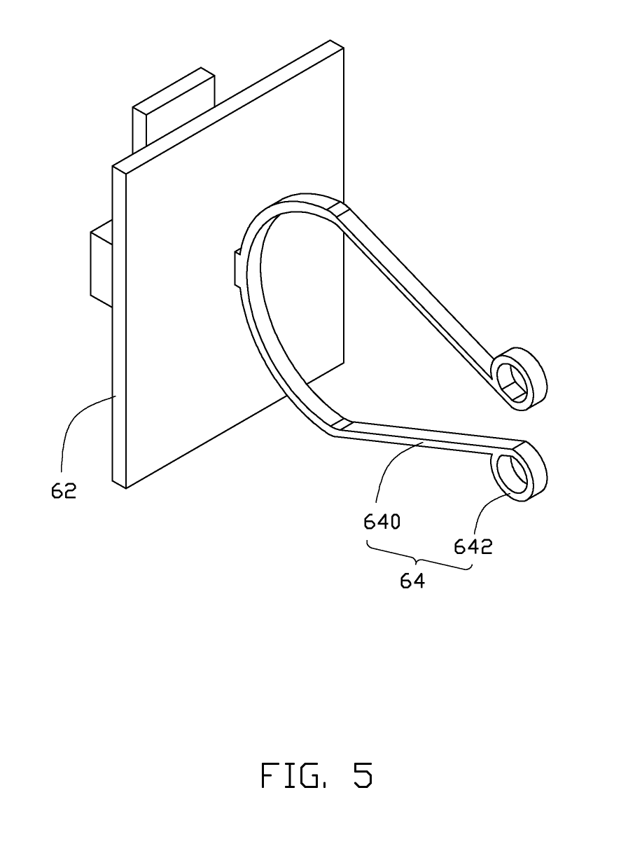

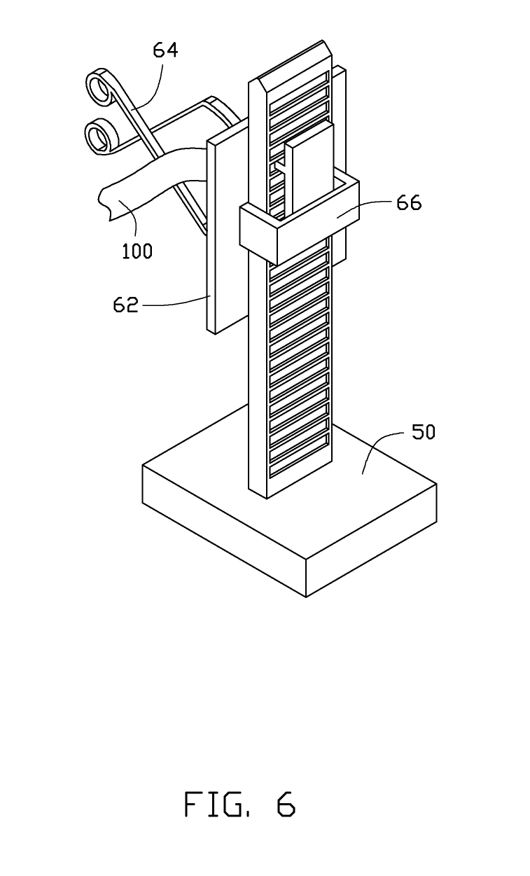

Referring to FIGS. 4 to 6, a second exemplary embodiment of a cable management apparatus used to bind the cables 100 includes a bracket 50 substantially similar to the bracket 30 of the first embodiment, and a clamp 60 mounted to the bracket 50.

The clamp 60 includes a substantially rectangular support plate 62, a binding member 64, and a latch member 66 substantially similar to the latch member 46 of the first embodiment. The binding member 64 and the latch member 66 are positioned on opposite sides of the support plate 62, respectively. The binding member 64 includes a substantially C-shaped flexible binding strip 640 and two circular operation portions 642 formed on opposite ends of the binding strip 640. A center of an outer surface of the binding strip 640 opposite to the operation portions 642 is fixed to the support plate 62.

In assembly, the clamp 60 is fixed at a predetermined height of the post 54 of the bracket 50 by the latch member 66. In use, the binding strip 640 is deformed, causing the operation portions 652 to move away from each other. The cables 100 are accommodated in a receiving space bounded by the binding strip 640. The operation portions 642 are operated to deform the binding strip 640, with opposite ends of the binding strip 640 crossing each other, thereby restricting the cables 100. In disassembling the cables 100 from the clamp 60, the operation portions 642 are operated to make the opposite ends of the binding strip 640 uncross, thereby the cables 100 are readily removed from the clamp 60.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. A cable management apparatus for binding cables, the cable management apparatus comprising:
a bracket comprising a post;
a clamp comprising a support plate, a binding member to accommodate the cables, and a latch member, wherein the binding member and the latch member are positioned on opposite sides of the support plate, respectively, and wherein the binding member comprises a binding strip and a clamp portion, a first end of the binding strip is formed from the support plate, a second end of the binding strip is detachably engaged with the clamp portion, and the binding strip is rotatable around the first end, and when engaged with the clamp portion, is operable to bind the cables;
wherein a through hole is bounded by the support plate and the latch member, the post of the bracket extends through the through hole of the clamp and adjustably engages with the latch member to adjustably fasten the clamp to the bracket.

2. The cable management apparatus of claim 1, wherein the bracket further comprises a base plate, the post extends from the base plate.

3. (canceled)

4. The cable management apparatus of claim, wherein the clamp portion comprises a first clamp sheet and a second clamp sheet both extending from the support plate, and a first portion extending from a distal end of the second clamp sheet toward the first clamp sheet, the second end of the binding strip is operable to be accommodated between the first and second clamp sheets and blocked by the first portion.

5. The cable management apparatus of claim 4, wherein a protrusion extends from the second end of the binding strip, and the protrusion is squeezed into a space between the first and second clamp sheets and engages with the first portion of the clamp portion.

6. The cable management apparatus of claim 5, wherein the protrusion is wedge-shaped in cross section.

7. The cable management apparatus of claim 4, wherein an operation portion extends outward from the binding strip, adjacent to the second end of the binding strip, for facilitating manual operation.

8. The cable management apparatus of claim 1, wherein the latch member comprises a substantially U-shaped limiting portion, the limiting portion comprises two parallel first limiting plates extending from the support plate, and a second limiting plate connected between distal ends of the first limiting plates and opposite to the support plate, wherein the through hole is bounded by the first limiting plates, the second limiting plate, and the support plate.

9. The cable management apparatus of claim 8, wherein the latch member further comprises a latch plate extending up from an inner side of the second limiting plate and facing the support plate.

10. The cable management apparatus of claim 8, wherein a latch protrudes from the latch plate, facing the support plate, the post of the bracket defines a plurality of latching slots, the latch is to selectively engage with one of the plurality of latching slots.

11. (canceled)

12. A cable management apparatus for binding cables, the cable management apparatus comprising:
a bracket comprising a post; and
a clamp comprising a support plate, a binding member to accommodate the cables, and a latch member, wherein the binding member and the latch member are positioned on opposite sides of the support plate, respectively;
wherein the latch member comprises a substantially U-shaped limiting portion, the limiting portion comprises two parallel first limiting plates extending from the support plate, and a second limiting plate connected between distal ends of the first limiting plates and opposite to the support plate, a through hole is bounded by the support plate, the first limiting plates, and the second limiting plate, and the post of the bracket extends through the through hole of the clamp and adjustably engages with the latch member to adjustably fasten the clamp to the bracket.

13. The cable management apparatus of claim 12, wherein the bracket further comprises a base plate, and the post extends from the base plate.

14. The cable management apparatus of claim 12, wherein the binding member comprises a binding strip and a clamp portion, a first end of the binding strip formed from the support plate, a second end of the binding strip is detachably engaged with the clamp portion, the clamp portion comprises a first clamp sheet and a second clamp sheet both extending from the support plate, and a first portion extending from a distal end of the second clamp sheet toward the first clamp sheet, wherein the binding strip is rotatable around the first end, and is operable to bind the cables, when the second end of the binding strip is operable to be accommodated between the first and second clamp sheets and blocked by the first portion.

15. The cable management apparatus of claim 14, wherein a protrusion extends from the second end of the binding strip, the protrusion is squeezed into a space between the first and second clamp sheets and engages with the first portion of the clamp portion after the second end of the binding strip is accommodated between the first and second clamp sheets.

16. The cable management apparatus of claim 15, wherein the protrusion is wedge-shaped in cross section.

17. The cable management apparatus of claim 14, wherein an operation portion extends outward from the binding strip, adjacent to the second end of the binding strip, for facilitating manual operation.

18. The cable management apparatus of claim 12, wherein the latch member further comprises a latch plate extending up from an inner side of the second limiting plate and facing the support plate.

19. The cable management apparatus of claim 12, wherein a latch protrudes from the latch plate, facing the support plate, the post of the bracket defines a plurality of latching slots, the latch is to selectively engage with one of the plurality of latching slots.

20. The cable management apparatus of claim 12, wherein the binding member comprises a substantially C-shaped flexible binding strip, a center of an outer surface of the binding strip is fixed to the support plate, opposite ends of the binding strip are operable to deform to bind the cables.
